(19) United States
(12) Patent Application Publication
(10) Pub. No.: US 2007/0259724 A1
(43) Pub. Date: Nov. 8, 2007

(54) Ball Cage For A Constant Velocity Universal Joint And Process Of Producing A Ball Cage

(76) Inventor: Alexander Pohl, Simmern (DE)

Correspondence Address: Dickinson Wright PLLC, 38525 Woodward Avenue, Suite 2000, Bloomfield Hills, MI, 48304, US

(21) Appl. No.: 11/743,289

(22) Filed: May 2, 2007

(30) Foreign Application Priority Data
May 4, 2006 (DE) 10 2006 020 711.4

(51) Int. Cl. F16D 3/00

(52) U.S. Cl. 464/144

(57) ABSTRACT

A ball cage (2) for a constant velocity universal joint. The ball cage (2) is an annular member with a longitudinal axis (A). In the annular member there are provided a plurality of windows (3) which are distributed around the circumference and which, in the circumferential direction, are separated from one another by longitudinal webs (4) and in the axial direction by annular webs (5, 6). In circumferential regions of the ball cage (2) in which there are arranged the windows (3), the annular webs (5, 6) have a greater radial wall thickness than in the circumferential regions of the ball cage (2) in which there are arranged longitudinal webs (4). A process of producing a ball cage as well as a constant velocity universal joint with a ball cage are also disclosed.

### TECHNICAL FIELD

The invention relates to a ball cage for a constant velocity universal joint, more particularly for a constant velocity plunging joint of the VL joint type; and to a process of producing such a ball cage as well as a constant velocity universal joint comprising such a ball cage.

### BACKGROUND OF THE INVENTION

Constant velocity universal joints are well known from the state of the art. In addition to the ball cage, they commonly comprise an outer joint part with outer ball tracks, an inner joint part with inner ball tracks as well as torque transmitting balls which are guided in pairs of tracks consisting of one outer ball track and one inner ball track. The balls are received in circumferentially distributed cage windows of the ball cage and, when the joint is articulated, they are guided onto the angle-bisecting plane. Plunging joints comprise straight or helical ball tracks and thus permit axial displacement movements and angular movements between the outer joint part and the inner joint part.

VL plunging joints (cross track joints) are a particular type of constant velocity universal joint. They comprise an outer joint part and an inner joint part each comprising first ball tracks which extend at first intersection angles relative to the longitudinal axis of the respective joint part, and second ball tracks which extend at second angles of intersection relative to the longitudinal axis of the respective joint part. The first and second angles of intersection are identical in size and extend in opposite directions relative to the longitudinal direction. One outer first ball track intersects one inner second ball track, and one outer second ball track intersects one inner first ball track. In each pair of tracks formed in this way by an outer and an inner ball track, there is received and guided a ball. The balls are held in windows of the ball cage in a common plane. The wording ‘intersect’ in this context means that first and second tracks forming a pair cross each other and the longitudinal axis at a distance.

U.S. Publication No. 2004/0137992 discloses a driveshaft assembly with a VL joint and a longitudinal plunging unit of a motor vehicle. The cage of the VL joint comprises an internally cylindrical guiding face by means of which it is guided on a spherical outer face of the inner joint part.

From U.S. Pat. No. 6,071,195, there is known a VL plunging joint wherein two first ball tracks and two second ball tracks are arranged so as to adjoin one another in the circumferential direction. DE 103 53 608 A1 describes a VL joint whose guiding flanks in the cage windows are fluted for the purpose of reducing the Hertzian pressure. In both documents, the cages comprise spherical inner faces which form an annular gap relative to the inner joint part when the joint is in the aligned condition.

DE 102 53 627 A1 proposes a ball cage for a constant velocity universal joint which, in its inner annular face, in the region of the webs, comprises axially extending widened assembly portions.

U.S. Pat. No. 5,410,902 describes a process of producing a ball cage for a constant velocity joint, with a round plate being used for deep-drawing a dish while forming outer and inner projections. Subsequently, the base of the dish is punched out. The edge of the dish is stamped out in those places which are intended for the windows. Finally, the windows are punched out.

U.S. Pat. No. 6,161,414 shows a process and a device for finishing the cage windows of a ball cage. The circumferentially extending edges of the cage windows are smoothed and made parallel by non-chip forming deformation.

From DE 38 18 730, there is known a so-called XL joint which comprises pairs of ball tracks which intersect one another and pairs of axis-parallel ball tracks.

### SUMMARY OF THE INVENTION

The present invention provides an improved ball cage for a constant velocity universal joint and a process of producing such a ball cage, with the ball cage being produced in an easy and cost-effective way. An improved constant velocity universal joint comprising such a ball cage is also disclosed.

A first solution provides a ball cage for a constant velocity joint, more particularly for a constant velocity plunging joint. The ball cage has an annular member with a longitudinal axis A. In the annular member there is provided a plurality of circumferentially distributed windows which, in the circumferential direction, are separated from one another by longitudinal webs and which, in the axial direction, are delimited by annular webs. In the circumferential regions of the ball cage in which the windows are positioned, the annular webs each comprise a greater radial wall thickness than in the circumferential regions of the ball cage in which the longitudinal webs are positioned.

An advantage of the present design is that the balls are arranged in the thickened circumferential regions of the annular webs. Thus, even at large articulation angles of the joint and the related radial movements of the balls relative to the ball cage, the balls are laterally guided at the guiding flanks of the annular webs. This results in an increase in the service life of the constant velocity universal joint. The inventive ball cage is suitable for those constant velocity universal joints wherein the ball cage is to be axially displaceable relative to the inner joint part. These are constant velocity plunging joints such as VL joints or XL joints.

According to one embodiment, the circumferential regions with a greater radial thickness are formed by radially inwardly directed, longitudinally extending thickened portions. The radial thickened portions each comprise a cylindrical surface portion and circumferentially adjoining transition portions. The cylindrical surface portions, altogether, serve to guide the ball cage relative to an outer face of the inner joint part. The outer face of the inner joint part is substantially double-conical with a spherical transition portion between the two conical portions when viewed in a longitudinal section. In this regard, it can be considered, and will be referred to as “roof-shaped”.

It is advantageous if the radial thickened portions in the circumferential direction are shorter than the windows, which means that the thickened portions are positioned entirely within the circumferential extension of an associated window and are thus restricted to the region in which the balls have to be laterally guided. Furthermore, when the joint is articulated, the webs of the inner joint part which are formed between two ball tracks are able to enter the recesses longitudinally extending between the thickened portions of the cage. This means that the hub geometry can be such that the ball enveloping angle in the ball track can be increased, which results in a longer service life of the joints. The windows are, as usual, positioned in a common central window plane.

According to a further embodiment—if viewed in a longitudinal section—the annular member comprises an axially undercut-free inner annular face, thus making it possible to use a profiled tube as a blank for producing the ball cage. In this way, there are formed annular webs with circumferential regions with a thicker and thinner wall thickness which permit an improved ball guidance. There is no need for the inner annular face of the annular member to be machined. This results in an overall simplification of the production process and shortened machining times for producing the ball cage. On its outside, the annular member—if viewed in a longitudinal section—comprises a roof-shaped outer annular face which serves to control the ball cage relative to a cylindrical inner face of the outer joint part.

A further solution provides a process of producing a ball cage for a constant velocity universal joint with the following process stages: providing a profiled tube whose cross-section is constant along its length, which, between an outer face and an inner face, comprises a plurality of longitudinally extending circumferential regions with a greater wall thickness and a plurality of longitudinally extending circumferential regions with a smaller wall thickness which alternate around the circumference with those with a greater wall thickness; cutting the profiled tube to length to form an annular part; working circumferentially distributed windows into the annular part in the circumferential regions with the greater wall thickness.

The ball cage produced in accordance with the invention offers the above-mentioned advantages of a simplified production process and shortened machining times. By using a profiled tube as a starting component, it is possible, from the start, to provide circumferential regions with a thicker and thinner wall thickness. There is no need for subsequently machining the inner face of the annular part, so that one production stage is eliminated.

According to another embodiment, the profiled tube comprises a cylindrical outer tube face. Furthermore, the profiled tube—if viewed in a cross-section can comprise an undulating inner tube face, with the undulating inner tube face forming the later circumferential regions with a thicker and thinner wall thickness. The circumferential regions of a greater wall thickness can be formed by radially inwardly directed, longitudinally extending thickened portions, with the thickened portions comprising a central cylindrical surface portion and circumferentially laterally adjoining transition portions.

A further process stage can also include turning the cylindrical outer face of the annular part so as to produce a roof-shaped outer annular face, if viewed in a longitudinal section. As an alternative to turning the outer face, it is conceivable to use different production methods, for example forming production methods.

The windows in the annular part can be produced by punching operations. However, other machining operations such as out-of-round turning or milling are also possible. The windows can be worked into a common plane of the annular part.

A further solution provides a constant velocity universal joint, more particularly a constant velocity plunging joint comprising an outer joint part with a group of outer ball tracks which intersect the longitudinal axis; an inner joint part with a group of inner ball tracks which intersect the longitudinal axis; wherein an outer ball track intersecting the longitudinal axis and a respective inner ball track intersecting the longitudinal axis intersect one another and jointly form a pair; torque-transmitting balls which are received and guided in the pairs of outer and inner ball tracks intersecting one another; and a ball cage with circumferentially distributed windows in which the torque transmitting balls are held in a common plane M, wherein the ball cage is designed in accordance with one of the above-mentioned embodiments.

By using an inventive ball cage, the constant velocity universal joint as a whole achieves a longer service life because the balls are well guided laterally by the circumferentially extending guiding flanks with a thicker wall thickness across the entire articulation angle of the joint. The higher service life is also achieved as a result of the larger enveloping angle of the balls in the respective ball tracks. Furthermore, the complete joint can be produced cost-effectively because there is no need for machining the inner face of the ball cage.

According to a first embodiment, the group of outer and inner ball tracks intersecting the longitudinal axis A comprises partial groups of ball tracks inclined in opposite directions. This means that there are provided first outer ball tracks which intersect the longitudinal axis A at first angles α1, and second outer ball tracks which intersect the longitudinal axis A at second angles α2 deviating therefrom. Furthermore, there are provided first inner ball tracks which intersect the longitudinal axis A at first angles β1 and second inner ball tracks which intersect the longitudinal axis A at second angles β2 deviating therefrom. The first angles α1 of the outer first ball tracks and the first angles β1 of the inner first ball tracks are identical in size and extend in opposite directions, and the second angles α2 of the outer second ball tracks and the second angles β2 of the inner second ball tracks are identical in size and extend in opposite directions. The joint formed in this way is referred to as a VL plunging joint.

According to another embodiment, the outer joint part can comprise a further group of outer ball tracks which extend parallel to the longitudinal axis A, and the inner joint part can comprise a further group of inner ball tracks which extend parallel to the longitudinal axis A, wherein an outer further ball track and an inner further ball track are positioned opposite one another and jointly form a pair. Each pair of ball tracks formed in this way accommodates and guides a ball. The ball tracks of the further group of axis-parallel ball tracks normally circumferentially alternate with the ball tracks of the group of ball tracks intersecting the longitudinal axis A. The constant velocity joint formed in this way is also referred to as an XL joint.

According to a second embodiment, the ball tracks of the group of outer ball tracks intersecting the longitudinal axis A are inclined in the same direction relative to one another; and the ball tracks of the group of inner ball tracks intersecting the longitudinal axis A are also inclined in the same direction relative to one another; wherein the angles α1 at which the ball tracks intersect the longitudinal axis A and the angles β1 at which the inner ball tracks intersect the longitudinal axis A are of identical size and extend in opposite directions. According to a preferred further embodiment, there is also provided a further group of axis parallel outer ball tracks and a further group of axis-parallel inner ball tracks (XL joint). It is usual for the axis-parallel ball tracks to be arranged so as to circumferentially alternate relative to the intersecting ball tracks.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should be made to the embodiments illustrated in greater detail in the accompanying drawings and described below by way of examples of the invention.

FIG. 1 shows an inventive ball cage for a constant velocity plunging joint:

A) in a perspective view;

B) in a side view;

C) in a longitudinal section along sectional line C-C of FIG. 1B;

D) in a longitudinal section along sectional line D-D of FIG. 1B; and

E) in a cross-section along sectional line E-E of FIG. 1C.

FIG. 2 is a side view of an annular part for producing the ball cage according to FIG. 1 which was separated from a profiled tube as a blank;

FIG. 3 shows an inventive constant velocity plunging joint in a first embodiment with an inventive ball cage according to FIG. 1:
A) in an axial view wherein the inner joint part is articulated relative to the outer joint part;
B) in a longitudinal section according to sectional line B-B of FIG. 3A.

FIG. 4 shows the constant velocity universal joint according to FIG. 3 in a partially developed view.

FIG. 5 shows an inventive constant velocity plunging joint in a second embodiment with an inventive ball cage according to FIG. 1 in a partially developed view.

FIG. 6 shows an inventive constant velocity plunging joint in a third embodiment with an inventive ball cage according to FIG. 1 in a partially developed view.

### DETAILED DESCRIPTION OF THE DRAWINGS

FIGS. 1A to 1E which will be described jointly below show a ball cage 2 for a constant velocity universal which will be described in greater detail below and which is provided in the form of a constant velocity plunging joint. The constant velocity plunging joint comprises an outer joint part with an internally cylindrical guiding face, an inner joint part with an outer convex guiding face and, the ball cage 2 for receiving torque transmitting balls.

The ball cage 2 is provided in the form of an annular member with a longitudinal axis A and comprises a plurality of circumferentially distributed windows 3 for receiving torque transmitting balls. Between two circumferentially adjoining windows 3, there are formed longitudinal webs 4 which connect two annular webs 5, 6 which laterally delimit the windows 3. The number of windows 3 depends on the number of balls used and normally amounts to six or eight. The windows 3 jointly define a plane M in which the balls are held. The plane M constitutes the angle-bisecting plane between the inner joint part and the outer joint part when the joint is articulated.

The ball cage 2 comprises an outer annular face 7 which comes into contact directly with the internally cylindrical guiding face of the outer joint part and thus serves to control the ball cage 2 relative to the outer joint part. The outer annular face 7 comprises an axially central spherical surface portion 8 or a similar barrel-shaped surface portion which is tangentially adjoined by conical surface portions 9, 10. The cone angle of the conical surface portions 9, 10 corresponds to approximately half the maximum articulation angle of the constant velocity plunging joint.

On its inside, the ball cage 2 comprises an undercut-free inner face 12, whose cross-section deviates from a cylindrical face. The inner face 12 is formed by the longitudinal webs 4 and the annular webs 5, 6. It can be seen that in circumferential regions of the ball cage which contain the windows 3, the annular webs 5, 6 comprise a greater wall thickness than in the intermediate circumferential regions in which there are positioned the longitudinal webs 4. Said circumferential regions with a greater wall thickness are formed by radially inwardly directed and longitudinally extending thickened portions 13, with a longitudinally extending recess 14 being formed between each two circumferentially adjoining thickened portions 13. The thickened portions 13 each contain a partially cylindrical surface portion 15 which, in a mounted condition, comes into contact with an outer face of the inner joint part (not illustrated here), as well as two circumferentially adjoining transition portions 16, 17 which end in the recesses 14. Two axially opposed thickened portions 13 form lateral guiding flanks 18 for guiding a ball held in the window 3.

It is advantageous if the radial thickened portions 13 in the circumferential direction are shorter than the windows 3 (FIG. 1C). In this way, when the joint is articulated, the webs of the inner joint part which are formed between two ball tracks are able to enter the recesses 14 extending between thickened portions 13 of the cage 2. This allows the hub geometry to be such that the ball enveloping angle in the ball track can be increased with a resulting increase in the service life of the joint.

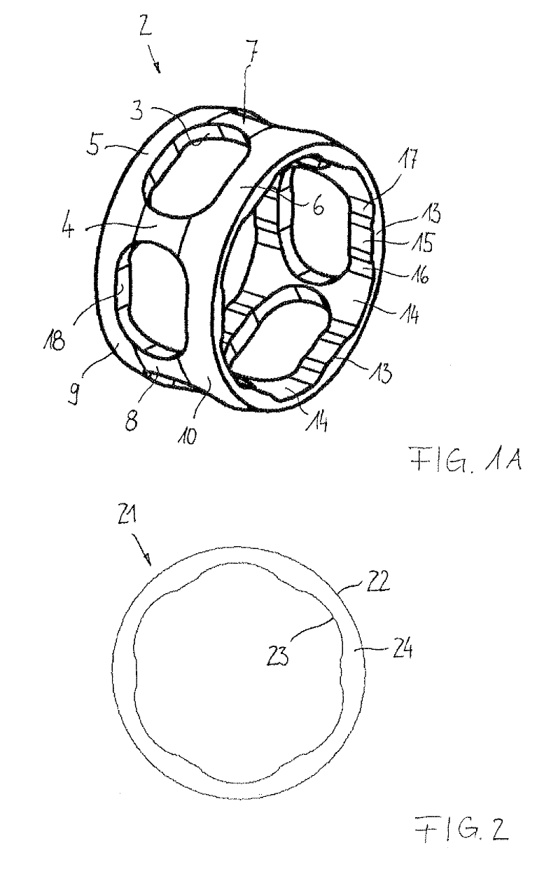

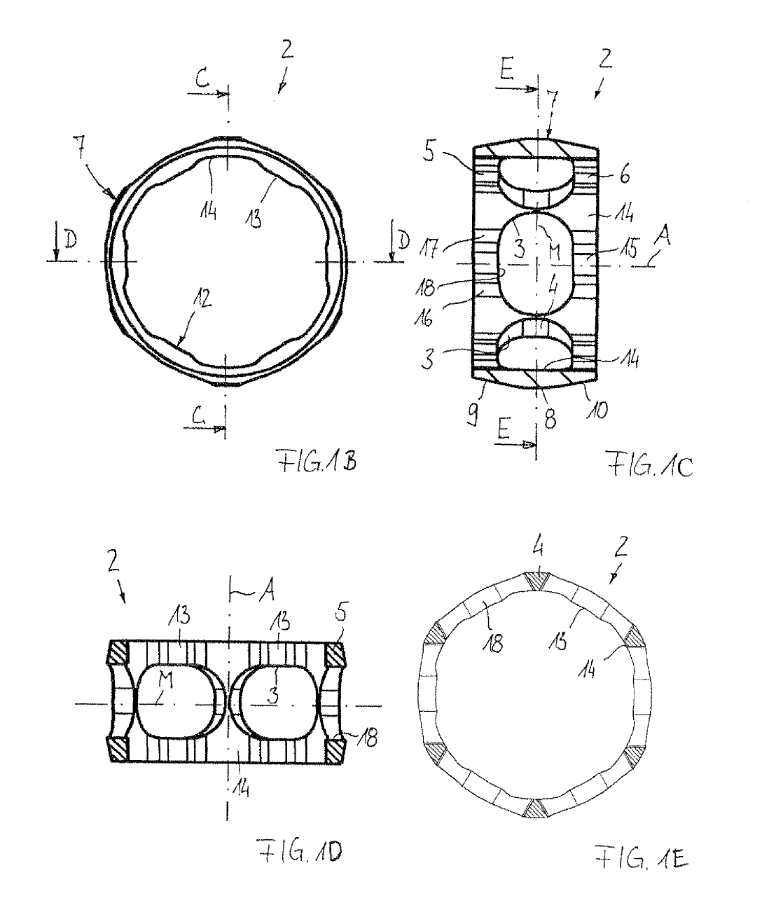

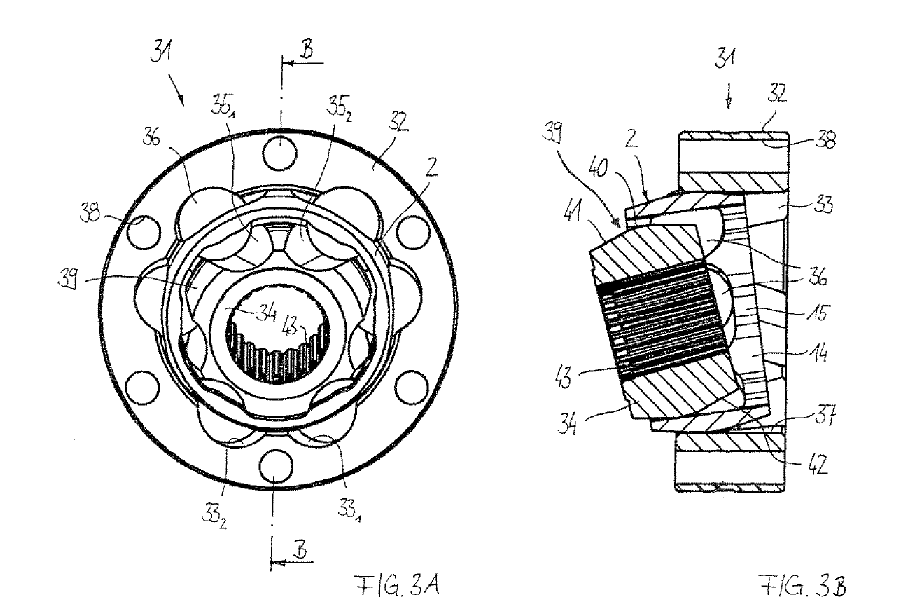

Because of the undercut-free design of the inner face 12 of the ball cage 2, the latter can be produced from an extruded profiled tube as the starting material. Such an extruded profiled tube comprises a cylindrical outer face and—if viewed in a cross-sectional view—an undulating inner face whose cross-section is constant along its length. In a first production stage, the profiled tube as provided is cut to lengths, so that there is obtained an annular part 21 with a closed surface. Such an annular part 21 is shown in FIG. 2, with the cylindrical outer face 22 and the undulating inner face 23 being identifiable. The inner face 23 can be provided in a finished form after this one step, thereby eliminating any need for subsequent machining of the inner face 23.

In a subsequent production stage, the windows are worked into the surface of the annular part 21, i.e. into the circumferential regions with the greater wall thickness. The windows are produced in such a way that they are regularly distributed around the circumference and are positioned in a common plane M. One production method of producing the windows can be a punching operation for example, but turning and milling operations are also possible. The ball cage 2 can be hardened after the punching operation.

In a further production stage, the outer face 22 of the annular part is machined to produce an outer annular face which, in a cross-sectional view, is roof-shaped. That is, the outer annular face 7 comprises an axially central spherical surface portion 8 or a similar barrel-shaped surface portion which is tangentially adjoined by conical surface portions 9, 10. This is preferably achieved by a turning operation, with forming production methods not being excluded. Furthermore, the axially opposed end faces 24 are machined.

The inner face 23 of the annular part 21 remains unmachined until the end, which means that production processes can be saved. The circumferential regions with the greater wall thickness of the annular part 21 form the thickened portions 13 of the finished ball cage 2, whereas the circumferential regions with the smaller wall thickness form the longitudinally extending recesses 14 extending between the thickened portions 13. By producing the recesses 14, material is saved and there is provided free space for the inner joint part when the joint 2 is articulated.

FIG. 3 shows an inventive constant velocity plunging joint 31 which comprises an annular outer joint part 32 with outer ball tracks 33, a hub-shaped inner joint part 34 with inner ball tracks 35, torque transmitting balls 36 guided in pairs of tracks consisting of one outer and one inner ball track 33, 34, as well as the inventive ball cage 2 according to the above-described design with circumferentially distributed windows 3 in which the balls 36 are guided.

Of the outer ball tracks, first ball tracks 33₁—if viewed across the circumference—comprise a first angle of intersection α1, with second ball tracks 33₂ comprising an angle of intersection α2 which is of the same size and extends in the opposite direction relative to the longitudinal axis A when the joint is in the aligned condition. Of the inner ball tracks, first ball tracks 35₁—if viewed across the circumference—comprise a first angle of intersection β1, with second ball tracks 35₂ comprising an angle of intersection β2 which is of the same size and extends in the opposite direction relative to the longitudinal axis A when the joint is in the aligned condition. Intersecting outer and inner ball tracks 33₁, 35₁; 33₂, 35₂ are circumferentially distributed and associated with one another in pairs, with the angles of intersection α1, β1; α2, β2 relative to the longitudinal axis A of the aligned joint being of identical size in the individual pairs and opening in opposite directions. This measure ensures the control function of the ball tracks 33, 35 for the balls 36 which are accommodated in the respective pairs of tracks and whose center is located in the point of intersection of the center lines of the pairs of tracks.

An internally cylindrical guiding face 37 for guiding the ball cage 2 can be seen in the outer joint part 32. The outer joint part 32 is provided with a plurality of circumferentially distributed through-bores 38 for threading in an attaching flange (not illustrated). The inner joint part 34—if viewed in a longitudinal section—comprises a roof-shaped guiding face 39 which is interrupted by the inner ball tracks 35. Again, the term “roof-shaped” means that the guiding face 39 composes a spherical surface portion 40 and tangentially adjoining conical surface portions 41, 42. The guiding face 39 guides the inner joint part 34 relative to the inner face 12 of the ball cage 2, i.e. by means of the partially cylindrical, longitudinally extending recesses 14 which are arranged in the circumferential direction between the thickened portions 13. Furthermore, the inner joint part 34 is provided with a central aperture 43 with longitudinal teeth for inserting a driveshaft.

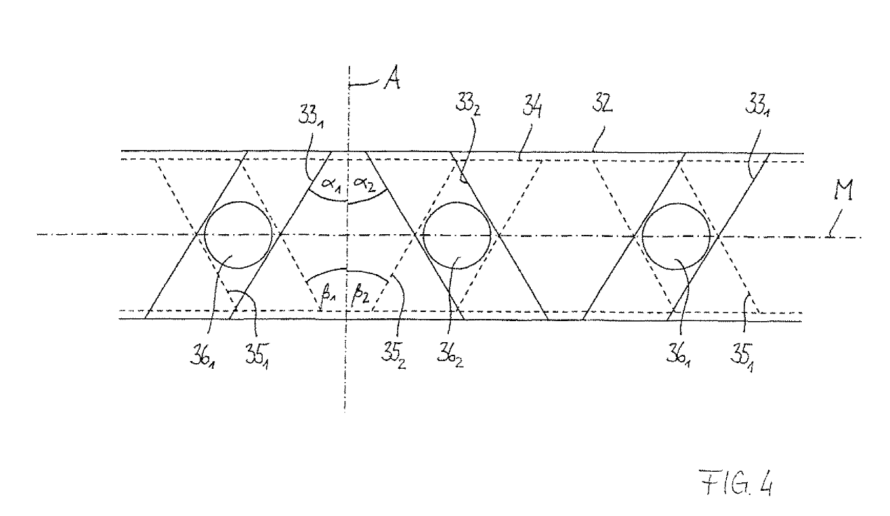

FIG. 4 is a developed view of the VL joint in the region of the ball tracks, such that the joint design and, in particular, the track configuration can be more easily understood. The outer joint part 32 shown by continuous lines and the inner joint part 34 shown in dashed lines are superimposed on one another. The outer joint part 32 is shown to comprise the first outer ball tracks 33₁ which, together with the longitudinal axis A, enclose the first angle of intersection α1; as well as the second outer ball tracks 33₂ which, together with the longitudinal axis A, form the angle of intersection α2 which is identical in size and opens in the opposite direction. Analogously, the inner joint part 34 is provided with first inner ball tracks 35₁ and second inner ball tracks 35₂ which also, together with the longitudinal axis A, form angles of intersection β1, β2 which are identical in size and open in opposite directions. The balls which are held by the ball cage 2 in a common plane M are referred to as first balls 36₁ and second balls 36₂. Because of the intersecting ball tracks 33, 35 of each pair of tracks, an axial force is applied to the balls when torque is transmitted. The axial force applied to the first balls 36₁ extends in the direction opposed to the axial force applied to the second balls 36₂. The ball cage 2 which has to hold the balls in a common plane M has to act against said axial forces. When the torque direction is reversed, the direction of the axial forces themselves is reversed, with the balls 36 contacting one of the guiding flanks 18 of their respective cage window 3. In the points of contact, there occurs a high Hertzian pressure which can lead to the ball cage being damaged. Because of the inventive design of the ball cage 2 with thickened portions 13 in the region of the windows 3, the radial extension of the guiding flanks 18 is increased, so that, even at large articulation angles, the balls comprise a sufficient distance from the edges of the guiding flanks 18. As a result, the wear in the contact regions is minimized and the service life of the joint is prolonged. In addition, the ball tracks 35 of the inner joint part 34 can be provided with larger enveloping angles relative to the balls 36, which also leads to an increase in the service life.

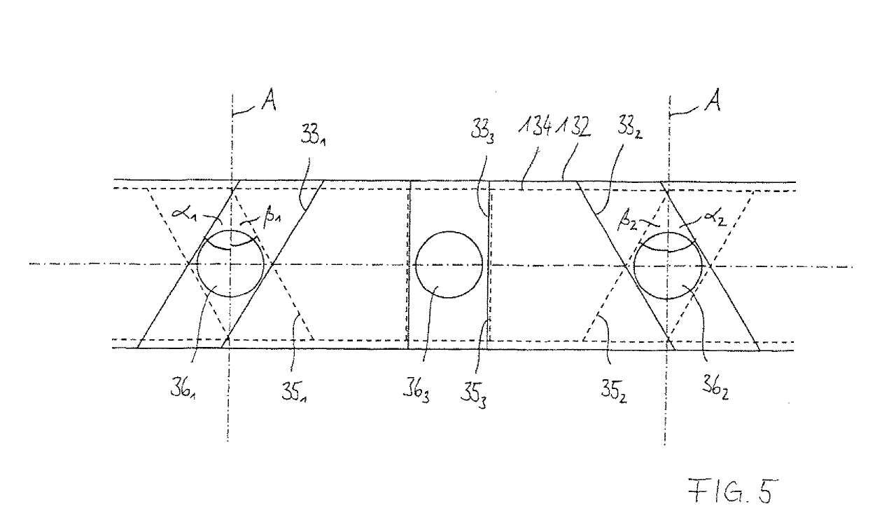

FIG. 5 shows a partially developed view of a constant velocity universal joint in a further embodiment. The design and mode of functioning of the present constant velocity universal joint largely correspond to the joint shown in FIGS. 3 and 4. To that extent, as far as the characteristics which the two joints have common are concerned, reference is made to the above descriptions, with similar components having been given the same reference numbers indexed by 100. It can be seen that the outer joint part 132 comprises a further group of outer third ball tracks 33₃ which extend parallel to the longitudinal axis A, and that the inner joint part 134 comprises a further group of inner third ball tracks 35₃ which extend parallel to the longitudinal axis A. One outer third ball track 33₃ and one inner third ball track 35₃ are positioned opposite one another and jointly form a pair. In each pair of axis-parallel ball tracks 33₃, 35₃ there is received and guided a ball 36₃. It can be seen that the pairs of axis parallel ball tracks 33₃, 35₃ alternate around the circumference with the pairs of intersecting ball tracks 33₁, 35₁; 33₂ 35₂.

The constant velocity universal joint formed in this way is also referred to as an XL joint. When the joint is aligned, only the balls 36₃ in the pairs of ball tracks 33₃, 35₃ extending parallel to the longitudinal axis A transmit a torque, whereas in the ball tracks 33₁, 35₁; 33₂ 35₂ intersecting the longitudinal axis A there occurs a free axial force at the balls 36₁, 36₂ under torque conditions. Said free axial force generates an axial compensating movement between the outer joint part 32 and the inner joint part 34 until the balls 36₁, 36₂ in the inclined ball tracks 33₁, 35₁; 33₂ 35₂ no longer comprise a force-transmitting track contact. The joint illustrated can be provided with three axis-parallel pairs of tracks and three pairs of tracks intersecting the axis, which two sets of three pairs of tracks alternate around the circumference and accommodate a total of six balls. Equally, the joint can comprise four axis-parallel pairs of tracks and four pairs of tracks intersecting the axis, which two sets of four pairs of tracks alternate around the circumference and accommodate a total of eight balls.

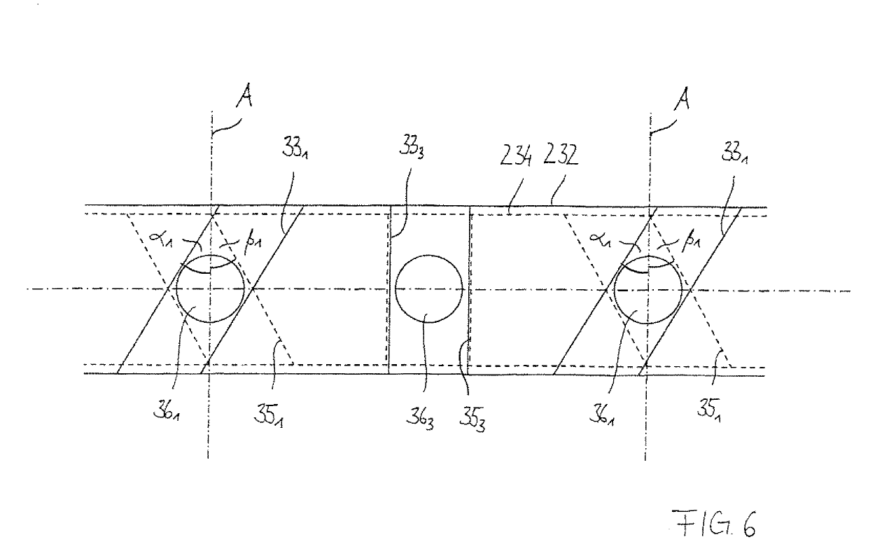

FIG. 6 shows a partially developed view of a constant velocity universal joint in a further embodiment. The design and mode of functioning of the present constant velocity universal joint largely correspond to the joint shown in FIG. 5. To that extent, as far as the characteristics which the two joints have common are concerned, reference is made to the above description, with similar components having been given the same reference numbers. Further indexed by 100. In contrast to the embodiment according to FIG. 5, the ball tracks of the group of outer ball tracks 33₁ extending at an angle relative to one another are all inclined in the same direction relative to one another, i.e. there is no partial group whose all tracks are inclined in an opposed direction. Accordingly, the ball tracks of the group of inner ball tracks 35₁ extending at an angle relative to the longitudinal axis A are all inclined in the same direction relative to one another. It can be seen that the angles α1 at which the inclined outer ball tracks 33₁ intersect the longitudinal axis A and the angles β1 at which the inclined inner ball tracks 35₁ intersect the longitudinal axis A are identical in size and extend in the opposite direction. The pairs of intersecting first ball tracks 33₁, 35₁ alternate with the pairs of axis-parallel third ball tracks 33₃, 35₃. This type of XL joint is thus characterised by the outer joint part 232 and the inner joint part 234 each comprising only two types of ball tracks. There can be provided embodiments with three axis-parallel pairs of tracks and three pairs of tracks intersecting the axis, which two sets of three pairs of tracks alternate around the circumference and accommodate a total of six balls. Equally, the joint can comprise four axis-parallel pairs of tracks and four pairs of tracks intersecting the axis, which two sets of four pairs of tracks alternate around the circumference and accommodate a total of eight balls.

While the invention has been described in connection with several embodiments, it should be understood that the invention is not limited to those embodiments. Rather, the invention covers all alternatives, modifications, and equivalents as may be included in the spirit and scope of the appended claims.

What is claimed is:

1. A ball cage for a constant velocity universal joint comprising:
an annular member with a longitudinal axis (A), the annular member having a plurality of windows distributed around its circumference and which, in the circumferential direction, are separated from one another by longitudinal webs and which, in the axial direction, are delimited by annular webs,
wherein, in circumferential regions of the annular member in which the windows are arranged, the annular webs each comprise a greater radial wall thickness than in the circumferential regions of the annular member in which the longitudinal webs are arranged.

2. A ball cage according to claim 1, wherein the circumferential regions with a greater radial wall thickness are formed by radially inwardly directed thickened portions.

3. A ball cage according to claim 1, wherein that the radial thickened portions each comprise a cylindrical surface portion and circumferentially adjoining transition portions.

4. A ball cage according to claim 2, wherein, in the circumferential direction, the radial thickened portions are shorter than the windows.

5. A ball cage according to claim 1, wherein, in a longitudinal sectional view, the annular member comprises an axially undercut-free inner annular face.

6. A ball cage according to claim 1, wherein, in a longitudinal sectional view, the annular member comprises a roof-shaped outer annular face.

7. A ball cage according to claim 1, wherein the annular member is produced from a profiled tube.

8. A process of producing a ball cage for a constant velocity universal comprising:
providing a profiled tube whose cross-section is constant along its length, which, between an outer tube face and an inner tube face, comprises a plurality of longitudinally extending circumferential regions with a greater wall thickness, and a plurality of longitudinally extending circumferential regions with a smaller wall thickness which alternate around the circumference with those with a greater wall thickness;
cutting the profiled tube to length to form an annular part; and
working circumferentially distributed windows into the annular part in the circumferential regions with the greater wall thickness.

9. A process according to claim 8, wherein the outer tube face of the profiled tube is formed so as to be cylindrical.

10. A process according to claim 8, wherein, in a cross-sectional view, the inner tube face of the profiled tube is designed so as to be undulating.

11. A process according to claim 8, wherein the circumferential regions with the greater wall thickness are formed by radially inwardly directed, longitudinally extending thickened portions.

12. A process according to claim 11, wherein the thickened portions each comprise a cylindrical surface portion and circumferentially laterally adjoining transition portions.

13. A process according to claim 8, wherein the inner face of the annular part remains unmachined.

14. A process according to claim 8, further process comprising:
turning the outer face of the annular part to produce a roof-shaped outer annular face if viewed in a longitudinal section.

15. A process according to claim 8, further comprising:
forming the outer face of the annular part to produce a roof-shaped outer annular face if viewed in a longitudinal section.

16. A process according to claim 8, wherein the windows are worked into the annular part by punching.

17. A process according to claim 8, wherein the windows are machined into the annular part in a chip-forming way.

18. A plunging constant velocity universal joint comprising:
an outer joint part with a group of outer ball tracks which intersect the longitudinal axis (A);
an inner joint part with a group of inner ball tracks which intersect the longitudinal axis (A), wherein an outer ball track intersecting the longitudinal axis (A) and an inner ball track intersecting the longitudinal axis (A) intersect one another and jointly form a pair;
torque-transmitting balls which are received and guided in the pairs of outer and inner ball tracks intersecting one another; and
a ball cage with circumferentially distributed windows in which the torque transmitting balls are held in a common plane (M), wherein the ball cage is designed in accordance with claim 1.

19. A constant velocity universal joint according to claim 18, wherein the ball tracks of the group of outer ball tracks intersecting the longitudinal axis (A) are inclined in the same direction relative to one another and form a first angle (α1), and the ball tracks of the group of inner ball tracks intersecting the longitudinal axis (A) are inclined in the same direction relative to one another and form a second angle (β1);
wherein the first angles (α1) and the second angles (β1) are of identical size and extend in opposite directions.

20. A constant velocity universal joint according to claim 18, wherein the group of outer ball tracks intersecting the longitudinal axis (A) comprise outer first ball tracks which intersect the longitudinal axis (A) at first angles (α1) and outer second ball tracks which intersect the longitudinal axis (A) at second angles (α2); and
that the group of inner ball tracks intersecting the longitudinal axis (A) comprise inner first ball tracks which intersect the longitudinal axis (A) at first angles (β1), and inner second ball tracks which intersect the longitudinal axis (A) at second angles (β2);
wherein the first angles (α1) of the outer first ball tracks and the first angles (β1) of the inner first ball tracks are identical in size and extend in opposite directions; and
wherein the second angles (α2) of the outer second ball tracks and the second angles (β2) of the inner second ball tracks are identical in size and extend in opposite directions.

21. A constant velocity universal joint according to claim 19, wherein the outer joint part comprises a further group of ball tracks which extend parallel to the longitudinal axis (A), and
the inner joint part comprises a further group of ball tracks which extend parallel to the longitudinal axis (A), wherein an outer further ball track and an inner further ball track are positioned opposite one another and jointly form a pair.

22. A constant velocity universal joint according to claim 20, wherein the outer joint part comprises a further group of ball tracks which extend parallel to the longitudinal axis (A), and
the inner joint part comprises a further group of ball tracks which extend parallel to the longitudinal axis (A), wherein an outer further ball track and an inner further ball track are positioned opposite one another and jointly form a pair.
